(19) United States
(12) Patent Application Publication
(10) Pub. No.: US 2014/0278707 A1
(43) Pub. Date: Sep. 18, 2014

(54) Commodity Procurement System

(71) Applicants: Martina Rothley, Schwetzingen (DE); Werner Neureuther, Karlsruhe (DE); Martin Szabadi, Heidelberg (DE); Steffen Vollmert, Frankfurt (DE); Peter Schlaak, Ilvesheim (DE)

(72) Inventors: Martina Rothley, Schwetzingen (DE); Werner Neureuther, Karlsruhe (DE); Martin Szabadi, Heidelberg (DE); Steffen Vollmert, Frankfurt (DE); Peter Schlaak, Ilvesheim (DE)

(73) Assignee: SAP AG, Walldorf (DE)

(21) Appl. No.: 13/796,430

(22) Filed: Mar. 12, 2013

(51) Int. Cl. G06Q 10/06

(52) U.S. Cl. CPC G06Q 10/06315
USPC 705/7.25

(57) ABSTRACT

A system and method include generating an indication regarding a need for a commodity from a manufacturing and resource planning system, estimating future prices of the commodity via a simulation tool as a function of current, historical, and simulated commodity prices, correlating the estimated future prices with a lead time to identify an optimal time to purchase the needed commodities, and generating a list of purchase orders via a computer system as a function of the correlation.

### BACKGROUND

Purchasing systems are used to provide commodities used in a manufacturing process sometimes identify quantities of commodities that need to be ordered, along with a time such commodities are needed. A person interacts with the purchasing system to generate purchase orders to ensure that the manufacturing process may continue in an uninterrupted manner.

### SUMMARY

A method includes generating an indication regarding a need for a commodity from a manufacturing and resource planning system, estimating future prices of the commodity via a simulation tool as a function of current, historical, and simulated commodity prices, correlating the estimated future prices with a lead time to identify an optimal time to purchase the needed commodities, and generating a list of purchase orders via a computer system as a function of the correlation.

A computer readable storage device has instructions for causing a computer to execute a method, the method including receiving an indication of a need for a commodity from a manufacturing and resource planning system, estimating future prices of the commodity via a tool as a function of current, historical, and simulated commodity prices, correlating the estimated future prices with a lead time to identify an optimal time to purchase the needed commodities, and generating a list of purchase orders via a computer system as a function of the correlation.

A system includes in memory database programmed to generate an indication regarding a need for a commodity from a manufacturing and resource planning system, estimate future prices of the commodity via a simulation tool as a function of current, historical, and simulated commodity prices, correlate the estimated future prices with a lead time to identify an optimal time to purchase the needed commodities, and generate a list of purchase orders via a computer system as a function of the correlation.

### BRIEF DESCRIPTION OF THE DRAWINGS

FIG. 1 is a block diagram of a system to optimize commodity purchasing for production according to an example embodiment.

FIG. 2 is a flowchart illustrating the use of simulated prices and stock to generate commodity purchase orders according to an example embodiment.

FIG. 3 is a mockup diagram of a dashboard to provide an interface to a purchasing system according to an example embodiment.

FIG. 4 is a screen shot of an in preparation list of purchase orders according to an example embodiment.

FIG. 5 is a screen shot of a purchase orders results list according to an example embodiment.

FIG. 6 is a block diagram of an example computer system to execute methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A system and method facilitate ordering of commodities for production to obtain a highest profitability and margin as a function of predicted best commodity prices. Commodity prices may have an impact on profit and margin especially if a production budget involves purchasing large volumes of commodities. The system and method takes into account demands for production such that commodities which are needed for production at a fixed point in time are available.

In one embodiment, a simulation tool predicts commodity prices and falling or rising trends to be able to order commodities using a best commodity price possible. Many different simulation tools may be used in various embodiments. An ordering application is used to make sure that the selected commodity price is used for all purchase orders at the same time to ensure that all demands for production will be available in time and quantity.

FIG. 1 is a block diagram of an example system 100 to optimize commodity purchasing for production. A user interface 110 is provided to a user to provide a dashboard type of interface into a purchase order application 115 and database 120. The application may be a materials requirements planning (MRP) type of application, such as SAP MRP or other system that assists with a manufacturing process to ensure materials are ordered and available for production.

In various embodiments, the user interface 110 may be coupled via a network connection to the application 115, which may run on local or remote server or cloud based system. Similarly, the database 120 may also be embodied in a separate server or cloud based system and connected to the application 115 in a similar manner.

A database engine 125 in one embodiment provides a simulation that predicts future commodity prices. The database may contain data used by the application 115, including for example, production information, purchase order information, and other information such as past commodity prices from previous orders and supplier invoices posted in a purchasing and production system. By using information from actual experiences, the simulation is self-learning and may improve in performance over time. The information may be extracted from business objects in one embodiment, or may simply be stored in a relational database and replicated for use by the simulation. In one embodiment, the database 120 and engine 125 form an in memory database, such as SAP Hana, where data is stored in random access memory for fast access. The engine may provide real time indices and aggregations of the data. Any other type of database may be used in further embodiments, but for large amounts of data, and in memory database may be more efficient.

The database engine 125 may further be coupled to outside information sources 130, such as various exchanges to provide commodity prices for a number of previous years. The engine 125 may also implement a simulation tool 135 that may integrate theoretical models regarding trend analysis, integrating common stock exchange rules, and further optionally integrating social engagement and media analytics regarding commodities in world economy and politics. Such social engagement and media analytics may be used to determine social sentiment. It may be thought of as a cloud based estimate of what social consensus is on an issue, from which commodity prices and their trends may be estimated.

The information may be obtained from various information sources 130, which may include cloud based resources, web sites, and other sources of public and private information. In one embodiment, an SAP transformation tool may be used to obtain real time date from various sources, including enterprise resource planning (ERP) and supplier relationship management (SRM) systems, and cloud based systems. The information may be used in the simulation of commodity prices and analysis for a user to use in managing purchase orders, supplier invoices, payment runs, and other activities related to purchasing commodities to support production.

FIG. 2 is a flowchart illustration of a method 200 for ordering commodities utilizing simulated commodity pricing to meet production demand. In one embodiment, a user purchaser orders the commodities needed when alerted by the simulation tool 135 via user interface 110. While the application 115 may have already scheduled purchase orders, the simulation may be used to stop those orders from being placed until simulated future prices and quantities are calculated. Two alerts/automatic notifications can occur stand-alone or combined as indicated at 210. One alert is generated if the (re-)order point of the product is reached or the stock falls below the minimum stock level. An alert may also be generated if the commodity price falls below a pre-defined threshold (e.g. 200 days best commodity price).

From the alert notification, the purchaser may enter a commodity price simulation/ordering optimization dashboard at 215 via the user interface 110. From the dashboard the user can see estimated prices of the commodity as a function of current, historical, and simulated commodity prices. The dashboard also provides a correlation of the estimated future prices with a lead time to identify an optimal time to purchase the needed commodities. The user can select an order function, such as by pushing an order button at 220. Depending on a user pre-configuration, on selecting the order function, the purchase orders are all sent to the suppliers at 225, and the purchaser receives a result list which can be checked at 230, or the purchaser gets a list of purchase orders in preparation which can be controlled, changed and sent to the suppliers at 235.

Replenishment lead time is a limiting factor sometimes forcing the purchaser to order at a non-optimized commodity price to avoid the risk of production shortages. Orders may be edited as indicated at 230 to avoid such risk.

After the order process is executed successfully either automatically or manually, the purchaser gets a result list 240 in one embodiment with information in the form of a row for each purchase order that may include information selected from supplier name, purchase order ID/item ID, product, quantity+unit of measure, regular commodity price (without simulation and adjustment of order point in time), simulated and used commodity price (balancing best simulated commodity price and order point in time to avoid the risk of production shortage), savings (difference of regular and simulated commodity price*sum of all quantities) in % and amount. The information may be displayed in a spreadsheet style on interface 110 in one embodiment.

An example dashboard is shown at 300 in FIG. 1 and consists of two parts. An upper part 310 shows the development of the simulated commodity price for one specific commodity, e.g. crude oil in the form of a price versus time. A lower part 315 shows the accumulated quantities (barrels) needed for this commodity in the purchaser's company on the timeline with indication of a maximum stock level at broken line 320 and a minimum stock level at broken line 325. The maximum stock level may be determined based on the amount of storage for the commodity available. The maximum stock level should not be exceeded in some embodiments. The lower part 315 provides a graphical representation of the development of all demands of one commodity needed at a specific point in time on the timeline. A vertical line 330 indicates the current date and extends through both parts of the dashboard 300.

A list of different commodities for which to view the graphs is shown at 335. Alerts for each part of the dashboard are shown in list form at 340. A first alert 345 corresponds to a commodity price falling below a predefined fictitious threshold 350, such as 200 days best commodity price indicated at 355 on the upper graph 310. A second alert 360 corresponds to a minimum stock level being predicted as indicated at 365 on the lower graph 315.

Both alerts are seen as occurring in the future and are based on predictions. The stock level may be generated by production software that keeps track of demand for product and materials inventory on hand and in the process of being obtained. The price alert was generated via the simulation tool 135 that predicts future commodity prices. Different simulation tools may be used in various embodiments, and may be changed as better simulation tools become available. The simulation tool simply provides estimates of prices in the future in a manner trusted by management of the company producing products.

In one embodiment, the dashboard provides a suggested order based on the simulation as indicated in a pop-up window 370. In one embodiment, the purchase order system identifies a projected price and an amount of commodity that should be ordered based on the simulation. A replenishment lead time is also taken into account by the simulation. An expected delivery date may be obtained from past experiences in delivery dates, and by communicating with various vendors regarding delivery dates if an order is to be placed at the date identified as the optimal data by the simulation. Pop-up window 370 may contain a link showing more information regarding one or more purchase orders that are recommended by the simulation tool.

An order button 375 is provided to select an order function. If the purchaser uses the order button, either an in preparation purchase order list 400 in FIG. 4 is provided, or a result list of all purchase orders sent if the purchase orders were created automatically as shown at 500 in FIG. 5.

List 400 provides a list of purchase orders which are in preparation as indicated in a status field 410. A purchaser order ID column 415 provides a list of purchase order IDs, followed by a column indicating date created at 420, supplier name at 425, total net value 430, PO acknowledgment 435, delivery status 440, invoicing status 445 and company name 450. Different columns may be provided in further embodiments depending on the needs or preferences of the user. The orders may be modified by the user, deleted, or new orders may also be created. Selected orders may also be sent to suppliers.

List 500 shows orders that have been placed. Columns are provided to identify product at 510, purchase order ID at 515, item at 520, purchase order status at 522, item description at 525 and quantity at 530. Further columns provide a regular commodity price at 535 (without simulation and adjustment of order point in time), simulated and used commodity price at 540 (balancing best simulated commodity price and ordering without risk of production shortage), and a calculated savings at 545 (difference of regular and simulated price*sum of all quantities) in % and amount.

FIG. 6 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 610. A hard drive, CD-ROM, and RAM are some examples of articles including a non-transitory computer-readable medium. For example, a computer program 625 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 610 to provide generic access controls in a COM based computer network system having multiple users and servers.

### EXAMPLES

### Example 1

A method comprising

generating an indication regarding a need for a commodity from a manufacturing and resource planning system;

estimating future prices of the commodity via a simulation tool as a function of current, historical, and simulated commodity prices;

correlating the estimated future prices with a lead time to identify an optimal time to purchase the needed commodities; and

generating a list of purchase orders via a computer system as a function of the correlation.

### Example 2

The method of example 1 wherein the indication comprises an alert.

### Example 3

The method of example 2 wherein the alert is based on a stock of the commodity falls below a minimum specified stock level or if a reorder point based on the lead time is reached.

### Example 4

The method of any one of examples 2-3 wherein the alert is based on the commodity price falling below a selected threshold.

### Example 5

The method of any one of examples 1-4 wherein the simulation tool comprises an in memory database based commodity price simulator.

### Example 6

The method of example 5 wherein the simulation tool integrates theoretical models regarding trend analysis.

### Example 7

The method of any one of examples 5-6 wherein the simulation tool integrates commodity exchange rules.

### Example 8

The method of any one of examples 5-7 wherein the simulation tool integrates social media analytics regarding human perceptions related to the commodity.

### Example 9

The method of any one of examples 1-9 and further comprising generating a dashboard user interface providing a graph of commodity cost versus time and a graph of projected commodity quantity in stock versus time.

### Example 10

The method of example 9 wherein the dashboard provides a list of commodities to select and alerts for the commodity selected and shown in the graphs.

### Example 11

The method of example 10 wherein the alerts comprise a price threshold met and a minimum stock threshold passed.

### Example 12

The method of any one of examples 9-11 wherein the dashboard further comprises an order button, selection of which generates purchase orders based on the alerts.

### Example 13

The method of example 12 wherein the generated purchase orders may be sent directly to suppliers on selection of the order button, or may be edited and sent to the suppliers.

### Example 14

The method of any one of examples 1-13 and further comprising providing analytics based on the list of purchase orders indicating cost savings realized by the purchase orders.

### Example 15

A computer readable storage device having instructions for causing a computer to execute a method, the method comprising:

receiving an indication of a need for a commodity from a manufacturing and resource planning system;

estimating future prices of the commodity via a tool as a function of current, historical, and simulated commodity prices;

correlating the estimated future prices with a lead time to identify an optimal time to purchase the needed commodities; and

generating a list of purchase orders via a computer system as a function of the correlation.

### Example 16

The computer readable storage device of example 15 wherein the indication comprises an alert, wherein the alert is based on a stock of the commodity falls below a minimum specified stock level, if a reorder point based on the lead time is reached, or is based on the commodity price falling below a selected threshold.

### Example 17

The computer readable storage device of example 16 wherein the method further comprises generating a dashboard user interface providing a graph of commodity cost versus time and a graph of projected commodity quantity in stock versus time.

### Example 18

A system comprising and in memory database programmed to:

generate an indication regarding a need for a commodity from a manufacturing and resource planning system;

estimate future prices of the commodity via a simulation tool as a function of current, historical, and simulated commodity prices;

correlate the estimated future prices with a lead time to identify an optimal time to purchase the needed commodities; and

generate a list of purchase orders via a computer system as a function of the correlation.

### Example 19

The system of example 18 wherein the indication comprises an alert based on at least one of a stock of the commodity falling below a minimum specified stock level, a reorder point based on the lead time being reached, and the commodity price falling below a selected threshold.

### Example 20

The system of any one of examples 18-19 and further comprising a dashboard user interface to provide a graph of commodity cost versus time and a graph of projected commodity quantity in stock versus time, wherein the dashboard provides a list of commodities to select and alerts for the commodity selected and shown in the graphs.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
generating an indication regarding a need for a commodity from a manufacturing and resource planning system;
estimating future prices of the commodity via a simulation tool as a function of current, historical, and simulated commodity prices;
correlating the estimated future prices with a lead time to identify an optimal time to purchase the needed commodities; and
generating a list of purchase orders via a computer system as a function of the correlation.

2. The method of claim 1 wherein the indication comprises an alert.

3. The method of claim 2 wherein the alert is based on a stock of the commodity falls below a minimum specified stock level or if a reorder point based on the lead time is reached.

4. The method of claim 2 wherein the alert is based on the commodity price falling below a selected threshold.

5. The method of claim 1 wherein the simulation tool comprises an in memory database based commodity price simulator.

6. The method of claim 5 wherein the simulation tool integrates theoretical models regarding trend analysis.

7. The method of claim 5 wherein the simulation tool integrates commodity exchange rules.

8. The method of claim 5 wherein the simulation tool integrates social media analytics regarding human perceptions related to the commodity.

9. The method of claim 1 and further comprising generating a dashboard user interface providing a graph of commodity cost versus time and a graph of projected commodity quantity in stock versus time.

10. The method of claim 9 wherein the dashboard provides a list of commodities to select and alerts for the commodity selected and shown in the graphs.

11. The method of claim 10 wherein the alerts comprise a price threshold met and a minimum stock threshold passed.

12. The method of claim 9 wherein the dashboard further comprises an order button, selection of which generates purchase orders based on the alerts.

13. The method of claim 12 wherein the generated purchase orders may be sent directly to suppliers on selection of the order button, or may be edited and sent to the suppliers.

14. The method of claim 1 and further comprising providing analytics based on the list of purchase orders indicating cost savings realized by the purchase orders.

15. A computer readable storage device having instructions for causing a computer to execute a method, the method comprising:
receiving an indication of a need for a commodity from a manufacturing and resource planning system;
estimating future prices of the commodity via a tool as a function of current, historical, and simulated commodity prices;
correlating the estimated future prices with a lead time to identify an optimal time to purchase the needed commodities; and
generating a list of purchase orders via a computer system as a function of the correlation.

16. The computer readable storage device of claim 15 wherein the indication comprises an alert, wherein the alert is based on a stock of the commodity falls below a minimum specified stock level, if a reorder point based on the lead time is reached, or is based on the commodity price falling below a selected threshold.

17. The computer readable storage device of claim 16 wherein the method further comprises generating a dashboard user interface providing a graph of commodity cost versus time and a graph of projected commodity quantity in stock versus time.

18. A system comprising and in memory database programmed to:
generate an indication regarding a need for a commodity from a manufacturing and resource planning system;
estimate future prices of the commodity via a simulation tool as a function of current, historical, and simulated commodity prices;
correlate the estimated future prices with a lead time to identify an optimal time to purchase the needed commodities; and
generate a list of purchase orders via a computer system as a function of the correlation.

19. The system of claim 18 wherein the indication comprises an alert based on at least one of a stock of the commodity falling below a minimum specified stock level, a reorder point based on the lead time being reached, and the commodity price falling below a selected threshold.

20. The system of claim 18 and further comprising a dashboard user interface to provide a graph of commodity cost versus time and a graph of projected commodity quantity in stock versus time, wherein the dashboard provides a list of commodities to select and alerts for the commodity selected and shown in the graphs.
